(19) United States
(12) Patent Application Publication
(10) Pub. No.: US 2020/0117751 A1
(43) Pub. Date: Apr. 16, 2020

(54) CONTEXT-AWARE COMPUTING APPARATUS AND METHOD OF DETERMINING TOPIC WORD IN DOCUMENT USING THE SAME

(71) Applicant: Twinword Inc., Seongnam-si (KR)

(72) Inventor: Kun Oh Kim, Anyang-si (KR)

(21) Appl. No.: 16/155,997

(22) Filed: Oct. 10, 2018

(51) Int. Cl. G06F 17/30; G06F 17/27

(52) U.S. Cl. CPC G06F 17/30616; G06F 17/30716; G06F 17/2785; G06F 17/30707

(57) ABSTRACT

Provided are a context-aware computing apparatus and a method of determining a topic word in a document using the same. The context-aware computing apparatus includes a memory configured to store information including a word graph in which semantic relationships among words are recorded in a network form, and a processor connected to the memory. The processor extracts content words from an acquired document by analyzing the document, clusters, in the word graph, word associations lying within a certain semantic distance from the position of each content word in the word graph, determines a centroid vector, which is a semantic center, for the content words and the word associations, determines topic words in order of increasing semantic distance from the determined centroid vector among the content words and the word associations, and provides the determined topic words.

### BACKGROUND

### 1. Field of the Invention

The present invention relates to an information processing technology for determining a topic word in a document through context-awareness on the basis of data science and technology, and more particularly, to a context-aware computing apparatus and a method of determining a topic word in a document using the same.

### 2. Discussion of Related Art

In order to identify the subject of a document, it is necessary to extract the most important topic words from the source of information and provide the topic words. In this regard, a subject identification process of a human involves understanding a document and identifying the subject, and this process requires linguistic knowledge. Like the process of a human, a process in which a computer automatically identifies the subject of a document requires linguistic knowledge and a process of understanding the document. As for a computer, the linguistic knowledge is language resources including an electronic dictionary, WordNet, a sentence parser, and a morphological analyzer. The process of understanding the document is a process of extracting statistics using the language resources or identifying the subject in the form of a document topic word. As for a computer, subject identification is to determine some words which are most related to the subject of a document. When a computer determines a topic word which represents the content of a document best, the computer may be referred to as having identified the subject of the document.

### SUMMARY OF THE INVENTION

The present invention is directed to providing a context-aware computing apparatus capable of determining and providing a topic word best on the basis of awareness of document context and a method of determining a topic word in a document using the context-aware computing apparatus.

According to an aspect of the present invention, there is provided a context-aware computing apparatus including: a memory configured to store information including a word graph in which semantic relationships among words are recorded in a network form; and a processor configured to be connected to the memory. The processor extracts content words from an acquired document by analyzing the document, clusters, in the word graph, word associations which lie within a certain semantic distance from a position of each content word in the word graph, determines a centroid vector, which is a semantic center, for the content words and word associations, and determines and provides topic words in order of increasing semantic distance from the determined centroid vector from among the content words and the word associations. A semantic distance represents a physical distance based on a semantic similarity between words, and the clustered word associations may include words not in the document.

The processor may perform multi-step word clustering in which the M content words are expanded by generating a first word cluster composed of first word associations having a certain semantic similarity with M content words in the word graph, and the word associations are expanded again by generating a second word cluster composed of second word associations having a certain semantic similarity with the first word associations constituting the first word cluster in the word graph.

When performing the multi-step word clustering, the processor may compare expansion widths of the first word associations constituting the first word cluster and the second word associations constituting the second word cluster and expand the word associations by performing the multi-step word clustering until a width change slows to a predefined rate of expansion, and stops the multi-step word clustering when the width change slows to the predefined rate of expansion. In this case, the predefined rate of expansion may vary depending on document characteristics including a type and a genre of the document.

The processor may extract an A word group composed of only nouns from the content words and the word associations, select J (J is a positive integer) words from the extracted A word group on the basis of appearance frequency, determine a centroid vector, which is a semantic center, on the basis of a vector distribution of the selected J words, calculate semantic similarities between the centroid vector of a J word group and respective word vectors of the J word group, and select topic word candidates in order of decreasing semantic similarity.

The processor may provide a vocabulary level test to general users and maintain the word graph according to changes of words with regions and times by applying selection information of the users to the word graph through interaction with the users.

According to another aspect of the present invention, there is provided a method of determining a topic word in a document using a context-aware computing apparatus, the method being performed by the context-aware computing apparatus and including: acquiring a document and extracting content words from the document; clustering word associations lying within a certain semantic distance from a position of each content word in a word graph; determining a centroid vector, which is a semantic center, for the content words and word associations; and extracting topic words in order of increasing semantic distance from the determined centroid vector from the content words and the word associations and providing the extracted topic words. A semantic distance represents a physical distance based on a semantic similarity between words, and the clustered word associations may include words not in the document.

The clustering of the word associations in the word graph may include: displaying words of the word graph in a word-by-word matrix space; displaying, in the word-by-word matrix space, information values indicating how frequently each word element is used together with other word elements in context; representing each word displayed in the word-by-word vector space as a vector; expanding the word associations by generating a first word cluster composed of first word associations having a certain semantic similarity with M content words in the word graph; expanding the word associations again by generating a second word cluster composed of second word associations having a certain semantic similarity with the first word associations constituting the first word cluster in the word graph; and comparing expansion widths of the first word associations constituting the first word cluster and the second word associations constituting the second word cluster and expanding the word associations by performing multi-step word clustering until a width change slows to a predefined rate of expansion, and stopping the multi-step word clustering when the width change slows to the predefined rate of expansion.

The determining of the centroid vector may include: extracting an A word group composed of only nouns from the content words and the word associations; selecting J (J is a positive integer) words from the extracted A word group on the basis of appearance frequency; and determining a centroid vector, which is a semantic center, on the basis of a vector distribution of the selected J words, and the extracting and providing of the topic words may include calculating semantic similarities between the centroid vector of a J word group and respective word vectors of the J word group and selecting topic word candidates in order of decreasing semantic similarity.

The method may further include providing a vocabulary level test to general users and maintaining the word graph according to changes of words with regions and times by applying selection information of the users to the word graph through interaction with the users.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram of a context-aware computing system according to an exemplary embodiment of the present invention;

FIG. 2 is a block diagram of a context-aware computing system according to another exemplary embodiment of the present invention;

FIG. 3 is a block diagram of a context-aware computing apparatus according to an exemplary embodiment of the present invention;

FIG. 4 is a detailed block diagram of a processor of FIG. 3 according to an exemplary embodiment of the present invention;

FIGS. 5 and 6 show word graphs according to various exemplary embodiments of the present invention;

FIG. 7 shows an example of converting a word graph into a word-by-word matrix space according to an exemplary embodiment of the present invention;

FIG. 8 is a table showing an example of calculating semantic similarities using vector inner products on the basis of a word-by-word matrix space according to an exemplary embodiment of the present invention;

FIG. 9 shows an example of determining topic words in a document and tagging the topic words according to an exemplary embodiment of the present invention;

FIG. 10 is a flowchart illustrating a method of determining a topic word in a document according to an exemplary embodiment of the present invention;

FIG. 11 is a flowchart illustrating a word clustering method according to an exemplary embodiment of the present invention; and

FIG. 12 is a flowchart illustrating a process of extracting topic words on the basis of a semantic center according to an exemplary embodiment of the present invention.

### DETAILED DESCRIPTION OF EXEMPLARY EMBODIMENTS

Advantages and features of the present invention and a method of achieving the same will be clearly understood from embodiments described below in detail with reference to the accompanying drawings. However, the present invention is not limited to the following embodiments and may be implemented in various different forms. The embodiments are provided merely for complete disclosure of the present invention and to fully convey the scope of the invention to those of ordinary skill in the art to which the present invention pertains. The present invention is defined only by the scope of the claims. Throughout this specification, like reference numbers refer to like elements.

In describing the exemplary embodiments of the present invention, detailed descriptions of well-known functions or configurations will be omitted when it is determined that the detailed descriptions unnecessarily obscure the gist of the present invention. The terms used in the following description are terms defined in consideration of functionality in exemplary embodiments of the present invention and may vary depending on an intention or practice of a user or an operator, or the like. Therefore, definitions of terms used herein should be made based on content throughout the specification.

Each block of the appended block diagrams and flowcharts and combinations thereof may be implemented by computer program instructions (an execution engine). These computer program instructions may be provided to a processor of a general-purpose computer, a special-purpose computer, or another programmable data processing apparatus so that the instructions, which are executed via the processor of the computer or the other programmable data processing apparatus, create a means for implementing the functions specified in each block of the block diagrams or flowcharts.

These computer program instructions may also be stored in a computer-usable or computer-readable memory that may direct a computer or another programmable data processing apparatus to function in a particular manner so that the instructions stored in the computer-usable or computer-readable memory may produce an article of manufacture including instructions that implement the functions specified in each block of the block diagrams or flowcharts.

The computer program instructions may also be loaded onto a computer or another programmable data processing apparatus. Therefore, a series of operations may be performed on the computer or the other programmable apparatus to produce a computer-implemented process so that the instructions, which are executed on the computer or the other programmable data processing apparatus, may provide operations for implementing functions specified in each block of the block diagrams or flowcharts.

Also, each block or each operation may represent a portion of a module, a segment, or code which includes one or more executable instructions for implementing the specified logical functions. It should also be noted that in some alternative embodiments, the functions noted in the blocks or operations may occur out of order. For example, two blocks or operations shown in succession may, in fact, be executed substantially concurrently, or the blocks or operations may sometimes be executed in the reverse order of the corresponding functions as necessary.

Hereinafter, exemplary embodiments of the present invention will be described in detail with reference to the accompanying drawings. However, the present invention is not limited to the embodiments described herein and may be embodied in many different forms. These embodiments of the present invention are provided to fully convey the scope of the invention to those of ordinary skill in the art to which the present invention pertains.

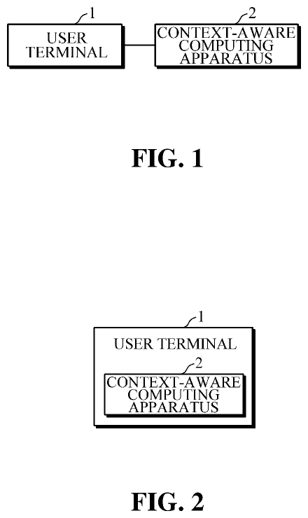

FIG. 1 is a block diagram of a context-aware computing system according to an exemplary embodiment of the present invention.

Referring to FIG. 1, the context-aware computing system includes a user terminal 1 and a context-aware computing apparatus 2.

The context-aware computing apparatus 2 provides a subject identification service of being aware of context of a document through big data processing on the basis of data science technology and identifying the subject, and may be based on artificial intelligence. The subject identification service provided by the context-aware computing apparatus 2 is a technology for handling human knowledge and document information, and subject identification targets are documents. Documents are content provided through webpages, applications, or the like and include text. Text may be composed of at least one sentence. The context-aware computing apparatus 2 may be supplied to service providers who intend to automatically identify subjects through various websites, applications, and the like.

The user terminal 1 according to an exemplary embodiment of the present invention is a client, and the context-aware computing apparatus 2 is a server. The user terminal 1 and the context-aware computing apparatus 2 are connected to each other via a network. For example, a website or an application executed in the user terminal 1 provides document text which is a subject identification target to the context-aware computing apparatus 2. The context-aware computing apparatus 2 determines topic words of the given document text and returns the determined topic words to the user terminal 1. The context-aware computing apparatus 2 may provide an open application programming interface (API).

The user terminal 1 is an electronic device which enables a user to use a website or an application. For example, the user terminal 1 may be any of various devices, such as a personal computer (PC), a cellular phone, a smart phone, a personal digital assistant (PDA), a tablet computer, a netbook, a portable multimedia player (PMP), a navigation device, and the like. The user terminal 1 supports a web browser for accessing websites and may install and execute applications therein.

The user terminal 1 provides a document to the context-aware computing apparatus 2 and receives back a topic word candidate list of the document from the context-aware computing apparatus 2. Here, the topic word candidate list includes words not used in the document as well as words used in the document, and words not used in the document may be topic words. For example, when “dog,” “cat,” “monkey,” “panda,” “horse,” etc. appear many times in the document, “animal” may be a topic word even if the word “animal” does not appear in the document. This is because the context-aware computing apparatus 2 may cluster, in a word graph, word associations lying within a certain semantic distance from words used in the document and select and provide appropriate topic words among the word associations.

A word graph is a semantic network of words. In a word graph, words are disposed apart from each other or close to each other according to the semantic distance therebetween. The context-aware computing apparatus 2 determines and uses a semantic distance between words in a word graph to identify the subject of text. A word graph may be a huge map or graph composed of numerous words.

A word graph according to an exemplary embodiment of the present invention is data obtained by grouping words having semantic distances within a preset range according to keyword. In this case, a word graph is composed of words having semantic distances within a preset range according to keyword. A semantic distance represents a physical distance based on a semantic similarity between words. A semantic similarity between words indicates the degree of association between two words. For example, words having relatively similar meanings are recorded at a short distance from each other, and words having dissimilar meanings are recorded at a long distance from each other. Words are disposed close to or apart from each other to constitute a word graph, and each word has different semantic distances from other words according to semantic similarities with the other words.

An example of extracting topic words from a document using a word graph according to an exemplary embodiment of the present invention is as follows. It is assumed that there is a sentence “The dogs jump very high while the cats crawl silently.” The context-aware computing apparatus 2 determines only the four words “dog,” “jump,” “cat,” and “crawl” as major content words. Also, the context-aware computing apparatus 2 extracts, from a word graph, word associations having short semantic distances from a position of each content word in the word graph. In this case, a word such as “animal” has the shortest semantic distance from “dog,” “jump,” “cat,” and “crawl” and thus is selected as a topic word.

The context-aware computing apparatus 2 according to an exemplary embodiment of the present invention manages a word graph required for document subject identification. When managing the word graph, the context-aware computing apparatus 2 may update the word graph appropriately for times and regions at which words are used. To this end, the context-aware computing apparatus 2 may load the word graph from a database, store the word graph in a memory, and manage the word graph. The database may be located in or outside of the context-aware computing apparatus 2.

FIG. 2 is a block diagram of a context-aware computing system according to another exemplary embodiment of the present invention.

Referring to FIG. 2, the user terminal 1 and the context-aware computing apparatus 2 may be integrally formed as the context-aware computing system. For example, as shown in FIG. 2, the context-aware computing apparatus 2 may be included in the user terminal 1. In this case, the context-aware computing apparatus 2 may use functions of the user terminal 1. In another example, the user terminal 1 itself may be replaced by the context-aware computing apparatus 2.

The context-aware computing apparatus 2 analyzes a document and extracts content words from the document. Also, the context-aware computing apparatus 2 clusters word associations lying within a certain semantic distance from the content words in a word graph. Then, the context-aware computing apparatus 2 determines topic words of the document among the content words and the word associations. Thereafter, topic word determination results are displayed through a display screen of the user terminal 1. The context-aware computing apparatus 2 may obtain the word graph required for topic word determination from a database stored in a separate server. When a word graph database is stored in the context-aware computing apparatus 2, it is possible to use the word graph database.

The context-aware computing apparatus 2 may be an apparatus separated from the user terminal 1 as shown in FIG. 1 or an apparatus integrally formed with the user terminal 1 as shown in FIG. 2. As necessary, some components of the context-aware computing apparatus 2 may be included in the user terminal, and some other components may be included in another apparatus separated from the user terminal 1.

FIG. 3 is a block diagram of a context-aware computing apparatus according to an exemplary embodiment of the present invention.

The configuration of the context-aware computing apparatus 2 shown in FIG. 3 is an example, and the context-aware computing apparatus 2 may include only some of the components shown in FIG. 3 or additionally include other components required for operation thereof. Each component of the context-aware computing apparatus 2 will be described in detail below with reference to FIG. 3.

Referring to FIG. 3, the context-aware computing apparatus 2 may include a bus 21, a processor 22, a memory 23, an input-output interface 24, a display 25, and a communication interface 26.

The bus 21 may be a circuit which connects components (e.g., the processor 22, the memory 23, the input-output interface 24, the display 25, and the communication interface 26) to each other and provides communication (e.g., transfer of a control message) among the components.

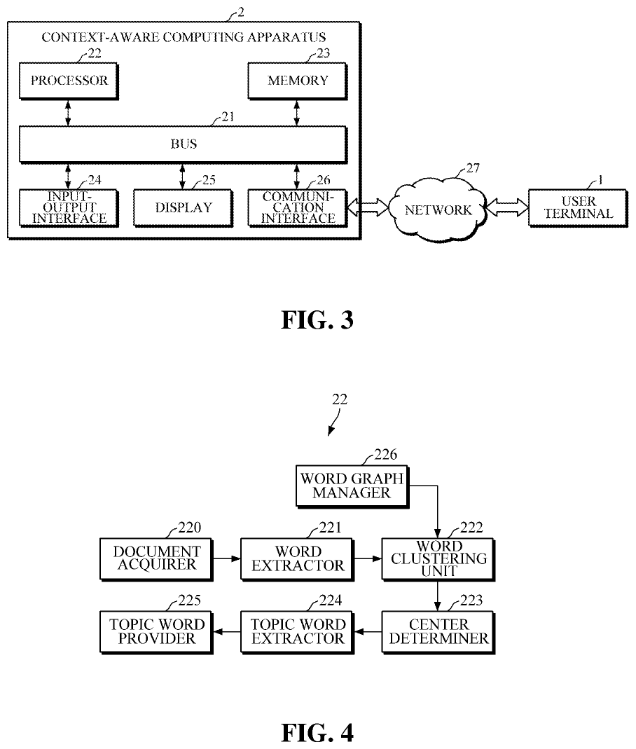

The processor 22 may receive an instruction from other components (e.g., the memory 23, the input-output interface 24, the display 25, and the communication interface 26), interpret the received instruction, and perform an arithmetic operation or data processing according to the interpreted instruction. The processor 22 according to an exemplary embodiment of the present invention extracts content words from a document by analyzing the document. Also, the processor 22 clusters word associations lying within a certain semantic distance from the position of each content word in a word graph. Subsequently, the processor 22 determines a topic word of the document among the extracted content words and extended word associations on the basis of semantic distances from a semantic center. A detailed configuration of the processor 22 will be described in detail below with reference to FIG. 4.

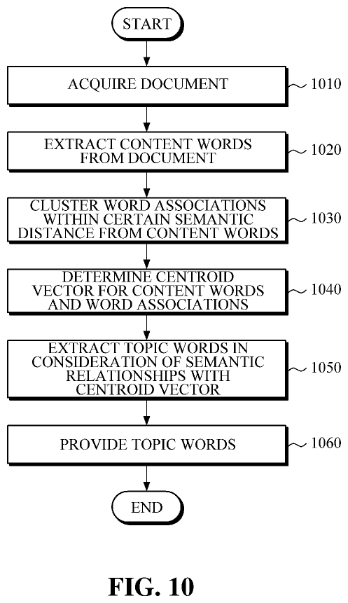

The memory 23 may store an instruction or data which is received from the processor 22 or other components (e.g., the input-output interface 24, the display 25, and the communication interface 26) or generated by the processor 22 or other components. For example, the memory 23 may store display information of at least one external context-aware computing apparatus which is input by at least one of an apparatus developer or an application program developer in a production operation for the context-aware computing apparatus 2. In the memory 23 according to an exemplary embodiment of the present invention, computer instructions to be executed by the processor 22 are stored. For example, computer instructions for performing respective operations, which will be described below with reference to FIGS. 10 to 12, may be stored in the memory 23.

A word graph is stored in the memory 23 according to an exemplary embodiment of the present invention. A word graph is data obtained by recording semantic relationships among words in a network form. Words having relatively similar meanings are recorded at a short distance from each other, and words having dissimilar meanings are recorded at a long distance from each other. Such a word graph stores semantic relationships and semantic distances between words in a form that may be processed by a computer, thereby serving as a useful knowledge base when a computer processes an algorithm related to artificial intelligence.

The input-output interface 24 may provide data or an instruction received from a user to the processor 22 or the memory 23 via the bus 21. The input-output interface 24 may output, via the bus 21, information received from the memory 23 or the communication interface 26. The input-output interface 24 may receive a document which is a topic word extraction target and output a document topic word extracted by the processor 22. The display 25 displays various kinds of information (e.g., content data, text data, or the like) to a user.

The communication interface 26 provides communication between the context-aware computing apparatus 2 and the user terminal 1. The communication interface 26 may support a specialized communication protocol (e.g., wireless fidelity (Wi-Fi), Wi-Fi direct, wireless gigabit alliance (WiGig), Bluetooth (BT), Bluetooth low energy (BLE), Zigbee, ultra wideband (UWB), near field communication (NFC), radio frequency identification (RFID), Audio Sync, electronic fee collection (EFC), human body communication (HBC), or visible light communication (VLC)) or network communication. A network 27 may be the Internet, a local area network (LAN), a wide area network (WAN), a telecommunication network, a cellular network, a satellite network, or a plain old telephone service (PoT) network.

FIG. 4 is a detailed block diagram of a processor of FIG. 3 according to an exemplary embodiment of the present invention.

Referring to FIGS. 3 and 4, the processor 22 according to an exemplary embodiment of the present invention includes a document acquirer 220, a word extractor 221, a word clustering unit 222, a center determiner 223, a topic word extractor 224, and a topic word provider 225 and may further include a word graph manager 226.

The document acquirer 220 acquires a document. The acquired document may be received from the user terminal 1 via the communication interface 26 or input via the input-output interface 24.

The word extractor 221 recognizes the document acquired by the document acquirer 220, segments the recognized document into words, excludes stop words from the segmented words, and then extracts content words on the basis of importance in the document.

The word extractor 221 according to an exemplary embodiment of the present invention segments the document into words, calculates the importance of each word in the document, and selects N words in order of decreasing importance. N is a positive integer and may be, for example, 300. The importance of each word may be calculated using at least one of a term frequency and an inverse document frequency. The term frequency represents how many times the corresponding word appears in the document. In this case, it is possible to select N words having relatively high appearance frequencies. An inverse document frequency tells whether the corresponding word is used commonly or rarely. This makes use of the fact that a rarely used word has high importance.

The word extractor 221 excludes stop words from the selected N words. Stop words include formal words, such as, prepositions, suffixes, articles, adverbs, and adjectives. To remove stop words, preprocessing such as morphological analysis and stemming may be performed. As an example of stemming, “swimming,” “swims,” and “swimmer” are changed to “swim.” Subsequently, M (M is a positive integer) content words are selected from among words from which stop words have been removed on the basis of importance of words in the document. M is a positive integer smaller than N and may be, for example, 10. The importance of a word may be calculated using at least one of a term frequency and an inverse document frequency.

The word clustering unit 222 clusters, in a word graph, word associations lying within a certain semantic distance from the position of each content word in the word graph. Words of similar meanings are at a short semantic distance. This is based on the assumption that words of similar meanings are used in similar context. For example, when the word “cat” is used in a document, it is highly likely that words including “dog,” “pet,” and “fur” are used together with the word “cat” in the document. Word associations used in similar environments are collected in the word graph through word clustering so that words may be expanded. Accordingly, word clustering based on the word graph makes it possible to search for a word that is not in the document but is highly likely to be a topic word of the document. For example, when “dog,” “cat,” “monkey,” “panda,” “horse,” etc. appear many times in the document, “animal” may be a topic word even if the word “animal” does not appear in the document. This is because the word “animal” which is at a short distance from “dog,” “cat,” “monkey,” “panda,” and “horse” in the word graph may be acquired through word clustering.

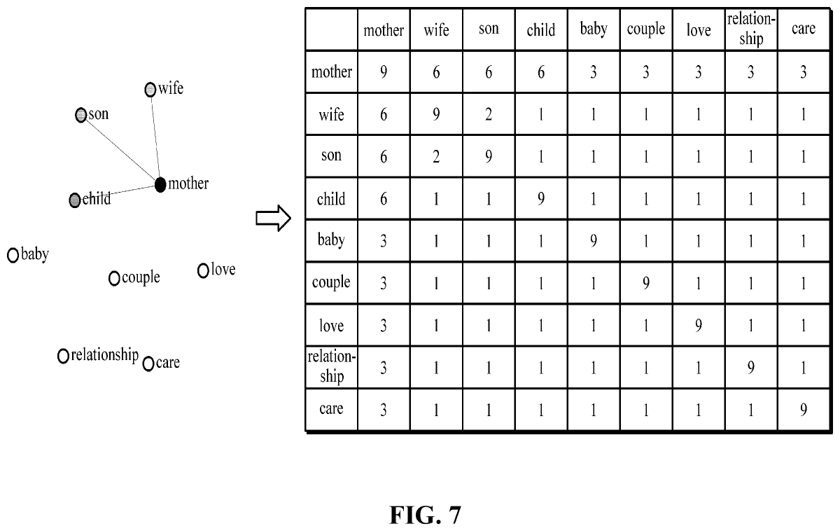

For word clustering, the word clustering unit 222 according to an exemplary embodiment of the present invention displays words of the word graph in a word-by-word matrix space. In the word-by-word matrix space, information values indicating how frequently each word element is used together with other word elements in context are displayed as numbers. Each word element constituting the word-by-word matrix space may be represented as a vector. A word-by-word matrix space will be described below with reference to FIG. 7.

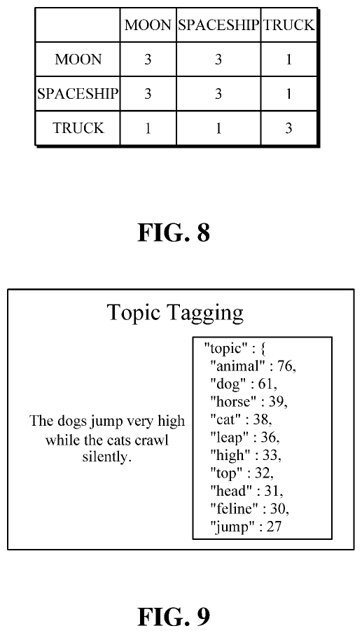

The word clustering unit 222 represents each word displayed in the word-by-word matrix space as a vector. Then, the word clustering unit 222 measures semantic similarities between word vectors. In the word graph, the word clustering unit 222 clusters word associations lying within a certain semantic distance from the position of each content word in the word graph. A semantic distance represents a physical distance based on a semantic similarity between words. A semantic similarity between word vectors indicates the degree of association between two word vectors. Clustered word associations may include words not used in the document. A similarity may be calculated using a cosine coefficient, a Jaccard coefficient, a dice coefficient, a vector inner product, a Euclidean distance, and the like. A cosine coefficient represents the cosine angle between two word vectors. A greater cosine angle denotes a higher semantic similarity between two words. An example of calculating a semantic similarity using a vector inner product will be described below with reference to FIG. 8. As for a Euclidean distance, a smaller distance value may denote that two words are more similar.

The word clustering unit 222 according to an exemplary embodiment of the present invention performs multi-step word clustering. In other words, after word associations of content words are expanded once, the expanded word associations are expanded again to new word associations. As an example of multi-step word clustering, word associations are expanded by generating a first word cluster composed of first word associations having a certain semantic similarity with M content words in the word graph. Subsequently, the word associations are expanded again by generating a second word cluster composed of second word associations having a certain semantic similarity with the first word associations constituting the first word cluster in the word graph.

It may be determined in advance how many steps will be performed in multi-step word clustering. As an example, it may be determined in advance to perform up to a second step. As another example, the number of steps to be performed may be determined according to a clustering environment, and the determination is based on whether a sufficient pool is provided. For example, the word clustering unit 222 compares expansion widths of a previous word cluster and a current word cluster and performs multi-step word clustering until a width change slows to a predefined rate of expansion, and stops the multi-step word clustering when the width change slows to the predefined rate of expansion. The width change may be an increase in the number of words constituting the current word cluster with respect to the number of words constituting the previous word cluster. Otherwise, the width change may be a percentage of words which are included in only one of the previous word cluster and the current word cluster. The predefined rate of expansion may be fixed at, for example, 20 to 30%. The rate of expansion may vary depending on document characteristics including a type and a genre of the document. In the case of literature including fiction and poems, various words are used. On the other hand, in the case of standardized writings including articles and theses, limited words may be used. Here, the rate of expansion may be set to 30% for a genre in which various words are used and set to 20% for a genre in which various words are not used. However, this is an exemplary embodiment for helping understanding of the present invention, and the present invention is not limited thereto.

In a word clustering operation, the word clustering unit 222 according to an exemplary embodiment of the present invention performs distributed processing (Map) on a word-by-word matrix and aggregates (Reduce) pieces of the word-by-word matrix through the MapReduce method, thereby reducing the load on a memory.

When an algorithm for word clustering or the like is executed, a large capacity of memory is required to rapidly make a calculation on a word-by-word matrix. For example, when about 1,000,000 features represent vectors, a matrix of 1,000,000×1,000,000×32 bits is necessary, which denotes that a total of about 30 gigabits of memory is necessary. When an excessively large memory size is necessary, computation is not possible. The MapReduce technique is used to calculate a matrix in a divide-and-conquer manner. In this case, each vector is separately calculated in the form of a key value, and thus it is unnecessary to use a large capacity of memory.

The center determiner 223 determines a centroid vector, which is a semantic center, for content word vectors and word association vectors. The center determiner 223 according to an exemplary embodiment of the present invention extracts an A word group composed of only nouns among the content words and word associations. Then, the center determiner 223 selects J (J is a positive integer) words from the extracted A word group on the basis of appearance frequency. Subsequently, the center determiner 223 determines a centroid vector, which is a semantic center, on the basis of a vector distribution of the selected J words.

As an example of centroid vector calculation, when J=3 and word vectors are A={a1, b1, c1}, B={a2, b2, c2}, and C={a3, b3, c3}, a centroid vector is {(a1+a2+a3)/J, (b1+b2+b3)/J, (c1+c2+c3)/J}. For example, when “moon”={3, 3, 1}, “satellite”={3, 3, 1}, and “truck”={1, 1, 3}, a centroid value is {(3+3+1)/3, (3+3+1)/3, (1+1+3)/3}={2.33, 2.33, 1.66}.

The topic word extractor 224 extracts topic words from among the content words and word associations in consideration of semantic relationships with the centroid vector determined by the center determiner 223. For example, the topic word extractor 224 calculates semantic similarities between the centroid vector of a J word group determined by the center determiner 223 and respective word vectors of the J word group and selects topic word candidates in order of decreasing semantic similarity. A semantic similarity between the centroid vector and a word vector may be calculated using a cosine coefficient, a Jaccard coefficient, a dice coefficient, an inner product, a Euclidean distance, and the like. When vector inner products are used, topic word candidates are selected in order or decreasing inner product.

The topic word provider 225 provides a topic word extracted by the topic word extractor 224. For example, the topic word is transferred to the user terminal 1 through the communication interface 26 or output through the input-output interface 24.

The word graph manager 226 provides a vocabulary test to general users and maintains the word graph according to changes of words with regions and times by applying selection information of the users to the word graph through interaction with the users. It is difficult to construct a word graph, and maintenance and update of a word graph also requires as much time and effort as initial construction due to linguistic characteristics which change over time. The word graph manager 226 according to an exemplary embodiment of the present invention automatically maintains the word graph. It is possible to construct and update the word graph by considering selection information of general users through interaction with the users. A vocabulary level test is provided to general users, and selection information of the users is received through interaction with the users. Then, a word graph is constructed and updated by applying the received selection information to the word graph. There are various examples of interaction with users, which include a free association method, a word selection method, a slider method, and the like.

The free association method involves constructing a test question for suggesting a stimulus word to a user and requesting the user to freely input a word first associated with the suggested stimulus word, and applying, to a word graph, a reaction word received from the user in response to the test question.

The word selection method involves constructing a test question for suggesting stimulus words and requesting a user to select a word which represents the user better from among the suggested stimulus words, and applying, to a word graph, a reaction word received from the user in response to the test question. As another example, it is possible to construct a test question for suggesting a stimulus word and words related to the stimulus word and requesting a user to select a word associated with the stimulus word from among the suggested words, and applying, to a word graph, a reaction word selected by the user in response to the test question.

The slider method involves constructing a test question for suggesting stimulus words and requesting a user to display a slide with a word which represents the user better from among the suggested stimulus words, and applying, to a word graph, a reaction word selected for a slide by the user in response to the test question. As another example, it is possible to construct a test question for suggesting a stimulus word and words related to the stimulus word and requesting a user to display a slide with a word associated with the stimulus word from among the suggested words, and applying, to a word graph, a reaction word selected by the user in response to the test question.

The above-described methods make it possible to collect information through interaction with users of various regions, analyze the collected information, and apply linguistic characteristics which continuously change over time to a word graph. Also, since it is possible to generate various word graphs according to changes with region and time, a word graph may be generated and updated at a low cost, and subject identification is facilitated through a word graph.

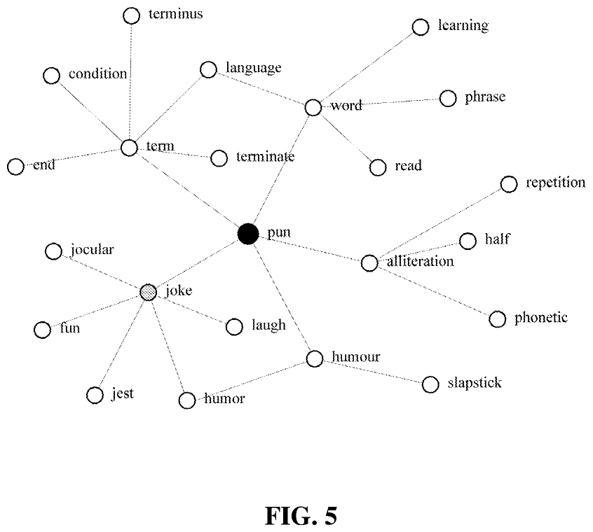

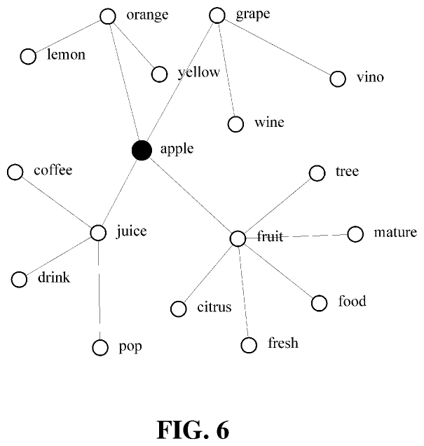

FIGS. 5 and 6 show word graphs according to various exemplary embodiments of the present invention.

Referring to FIG. 5, it is possible to see that a word graph is composed of words having close semantic relationships even with a word which is not frequently used such as “pun.” Referring to FIG. 6, it is possible to see that when a word such as “apple” is used as a proper noun as well as a common noun, a word graph is composed of general words rather than words related to the proper noun such as the company name “Apple Inc.”

Also, a word graph according to an exemplary embodiment of the present invention is maintained according to changes of words with regions and times. It is difficult to construct a word graph, and maintenance and update of a word graph also requires as much time and effort as initial construction due to linguistic characteristics which change over time. In a word graph management method according to an exemplary embodiment of the present invention, selection information which is fed back from general users through interaction with the users is applied to a word graph for maintenance.

When a word graph has better quality, it is possible to extract a more appropriate topic word from a document. Therefore, it is most important to improve the quality of a word graph.

FIG. 7 shows an example of converting a word graph into a word-by-word matrix space according to an exemplary embodiment of the present invention.

Referring to FIG. 7, a word graph is converted into a word-by-word matrix, and the word-by-word matrix may be represented with vectors. For example, as shown in FIG. 7, words constituting a word graph recorded centering around the word “mother” may be converted into vectors. When “mother” is represented as a vector {9, 6, 6, 6, 3, 3, 3, 3, 3}, the vector denotes that “mother” is as close as “6” to “wife,” “son,” and “child” and is as close as “3” “baby,” “couple,” “love,” “relationship,” and “care” in a word graph vector space.

FIG. 8 is a table showing an example of calculating semantic similarities using vector inner products on the basis of a word-by-word matrix space according to an exemplary embodiment of the present invention.

Referring to FIG. 8, it is assumed that a given document is composed of three sentences and all words used in each sentence are three words “moon,” “spaceship,” and “truck.” Here, a word-by-word matrix space is shown in FIG. 8. The word-by-word matrix space of FIG. 8 shows information values indicating how frequently each word element is used together with other word elements in context. For example, it is possible to see that the words “moon” and “spaceship” are used three times in the same sentence and the words “moon” and “truck” are used once in the same sentence. Each word may be represented as a word vector. For example, the words may be vectorized as follows: moon={3, 3, 1}, spaceship={3, 3, 1}, and truck={1, 1, 3}. Each vector inner product is calculated as follows: moon and spaceship=19((3×3)+(3×3)+(3+1)) and moon and truck=9((3×1)+(3×1)+(1×3)). In this way, it is possible to see that words having a large inner product (“moon” and “spaceship”) have a semantically closer relationship than words having a small inner product (“moon” and “truck”) and have a high semantic similarity.

FIG. 9 shows an example of determining topic words in a document and tagging the topic words according to an exemplary embodiment of the present invention.

Referring to FIG. 9, even if the word “animal” is not in a specific document, when words including “dog,” “cat,” etc. are frequently used in the document, the document is tagged with the subject “animal” like a human would do. For example, as shown in FIG. 9, the final end of a subject identification program according to an exemplary embodiment of the present invention is to automatically recommend “animal” 76 as an appropriate topic word candidate when the subject of input text is “animal” but the word “animal” is not in the input text.

FIG. 10 is a flowchart illustrating a method of determining a topic word in a document according to an exemplary embodiment of the present invention.

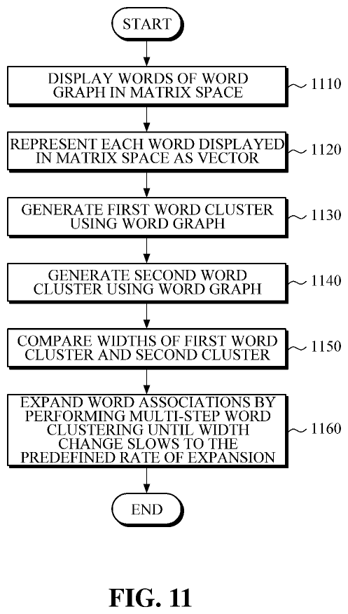

Referring to FIG. 10, a context-aware computing apparatus acquires a document (1010) and extracts content words from the acquired document (1020). Subsequently, the context-aware computing apparatus clusters, in a word graph, word associations lying within a certain semantic distance from the position of each content word in the word graph (1030). The word clustering operation (1030) will be described below with reference to FIG. 11.

Subsequently, the context-aware computing apparatus determines a centroid vector, which is a semantic center, (1040) for the content words acquired in the content word extraction operation (1020) and the word associations acquired in the word clustering operation (1030). Then, the context-aware computing apparatus extracts topic words from the content words and the word associations in order of increasing semantic distance from the centroid vector (1050) and provides the extracted topic words (1060).

FIG. 11 is a flowchart illustrating a word clustering method according to an exemplary embodiment of the present invention.

Referring to FIG. 11, the context-aware computing apparatus displays words in the word graph in a word-by-word matrix space (1110). At this time, the context-aware computing apparatus displays, in the word-by-word matrix space, information values indicating how frequently each word element is used together with other word elements in context.

Subsequently, the context-aware computing apparatus performs word clustering. For example, the context-aware computing apparatus measures semantic similarities between respective word vectors and clusters, in the word graph, word associations which have a certain semantic similarity with each content word used in the document. At this time, multi-step word clustering may be performed. For example, the context-aware computing apparatus expands the word associations by generating a first word cluster composed of first word associations having the certain semantic similarity with the content words in the word graph (1130). Then, the context-aware computing apparatus expands the word associations again by generating a second word cluster composed of second word associations having a certain semantic similarity with the first word associations constituting the first word cluster in the word graph (1140). Subsequently, the context-aware computing apparatus compares expansion widths of the first word associations constituting the first word cluster and the second word associations constituting the second word cluster (1150) and performs multi-step word clustering until the width change slows to a predefined rate of expansion, and stops the multi-step word clustering when the width change slows to the predefined rate of expansion (1160).

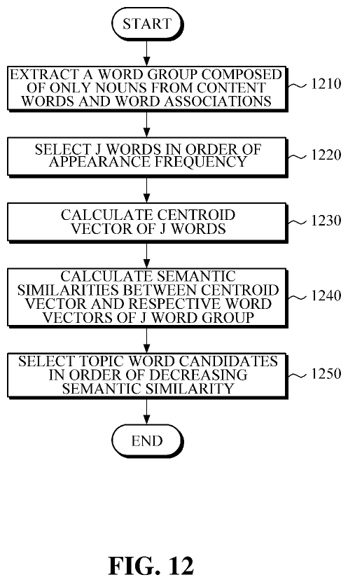

FIG. 12 is a flowchart illustrating a process of extracting topic words on the basis of a semantic center according to an exemplary embodiment of the present invention.

Referring to FIG. 12, the context-aware computing apparatus extracts an A word group composed of only nouns from the content words and the word associations (1210). Then, the context-aware computing apparatus selects J (J is a positive integer) words from the extracted A word group on the basis of appearance frequency (1220). Subsequently, the context-aware computing apparatus determines a centroid vector, which is a semantic center, on the basis of a vector distribution of the selected J words (1230). Then, the context-aware computing apparatus calculates semantic similarities between the centroid vector of a J word group and respective word vectors of the J word group (1240) and selects topic word candidates in order of decreasing semantic similarity (1260).

With a context-aware computing apparatus and a method of determining a topic word in a document using the same according to exemplary embodiments of the present invention, it is possible to determine a topic word best in a document. In particular, since a method of using a word graph, a method of performing multi-step word clustering, and a method of extracting topic words on the basis of a semantic center are used, it is possible to easily identify the subject of a document.

According to an exemplary embodiment, big data is collected and preprocessed through morphological analysis and the like using the natural language processing technology, which belongs to a field of artificial intelligence, and word associations used in similar environments are expanded through a word clustering algorithm based on a word graph. Therefore, words which do not appear in a document may be determined as the most appropriate topic words. Here, word associations may be expanded first, and then the expanded word associations may be expanded again through multi-step word clustering. Therefore, it is possible to select and provide a topic word appropriate for the given document.

Since performance of a word graph for subject identification is improved, it is possible to improve performance, which is based thereon, for identifying the subject of a document. For example, users' selection information is tagged by human computing and used to refine a word graph. Also, since the word graph is maintained according to changes of words with regions and times, the quality of the word graph can be increased.

Further, when an algorithm for word clustering or the like is executed, a word-by-word matrix is processed in a distributed manner (Map) and then aggregated (Reduce) through the MapReduce method. Therefore, it is unnecessary to use a large capacity of memory, and the load on a memory may be reduced.

Although exemplary embodiments of the present invention have been described in detail above, those of ordinary skill in the art to which the present invention pertains will appreciate that various modifications may be made without departing from the scope of the present invention. Therefore, these exemplary embodiments should be considered as illustrative rather than limiting. The scope of the present invention is to be determined by the following claims and their equivalents, and is not limited by the described exemplary embodiments.

What is claimed is:

1. A context-aware computing apparatus comprising:
a memory configured to store information including a word graph in which semantic relationships among words are recorded in a network form; and
a processor configured to be connected to the memory,
wherein the processor extracts content words from an acquired document by analyzing the document, clusters, in the word graph, word associations lying within a certain semantic distance from a position of each content word in the word graph, determines a centroid vector, which is a semantic center, for the content words and word associations, determines topic words from the content words and the word associations in order of increasing semantic distance from the determined centroid vector, and provides the determined topic words,
a semantic distance represents a physical distance based on a semantic similarity between words, and
the clustered word associations include words not in the document.

2. The context-aware computing apparatus of claim 1, wherein the processor performs multi-step word clustering in which the word associations are expanded by generating a first word cluster composed of first word associations having a certain semantic similarity with M content words in the word graph, and the word associations are expanded again by generating a second word cluster composed of second word associations having a certain semantic similarity with the first word associations constituting the first word cluster in the word graph.

3. The context-aware computing apparatus of claim 2, wherein, when performing the multi-step word clustering, the processor compares expansion widths of the first word associations constituting the first word cluster and the second word associations constituting the second word cluster and expands the word associations by performing the multi-step word clustering until a width change slows to a predefined rate of expansion, and stops the multi-step word clustering when the width change slows to the predefined rate of expansion.

4. The context-aware computing apparatus of claim 3, wherein the predefined rate of expansion varies depending on document characteristics including a type and a genre of the document.

5. The context-aware computing apparatus of claim 1, wherein the processor extracts an A word group composed of only nouns from the content words and the word associations, selects J (J is a positive integer) words from the extracted A word group based on appearance frequency, determines a centroid vector, which is a semantic center, based on a vector distribution of the selected J words, calculates semantic similarities between the centroid vector of a J word group and respective word vectors of the J word group, and selects topic word candidates in order of decreasing semantic similarity.

6. The context-aware computing apparatus of claim 1, wherein the processor provides a vocabulary level test to general users and maintains the word graph according to changes of words with regions and times by applying selection information of the users to the word graph through interaction with the users.

7. A method of determining a topic word in a document using a context-aware computing apparatus, the method being performed by the context-aware computing apparatus and comprising:
acquiring a document and extracting content words from the document;
clustering word associations lying within a certain semantic distance from a position of each content word in a word graph;
determining a centroid vector, which is a semantic center, for the content words and word associations; and
extracting topic words in order of increasing semantic distance from the determined centroid vector from the content words and the word associations and providing the extracted topic words,
wherein a semantic distance represents a physical distance based on a semantic similarity between words, and
the clustered word associations include words not in the document.

8. The method of claim 7, wherein the clustering of the word associations in the word graph comprises:
displaying words of the word graph in a word-by-word matrix space;
displaying, in the word-by-word matrix space, information values indicating how frequently each word element is used together with other word elements in context;
representing each word displayed in the word-by-word vector space as a vector;
expanding the word associations by generating a first word cluster composed of first word associations having a certain semantic similarity with M content words in the word graph;
expanding the word associations again by generating a second word cluster composed of second word associations having a certain semantic similarity with the first word associations constituting the first word cluster in the word graph; and
comparing expansion widths of the first word associations constituting the first word cluster and the second word associations constituting the second word cluster and expanding the word associations by performing multi-step word clustering until a width change slows to a predefined rate of expansion, and stopping the multi-step word clustering when the width change slows to the predefined rate of expansion.

9. The method of claim 7, wherein the determining of the centroid vector comprises:
extracting an A word group composed of only nouns from the content words and the word associations;
selecting J (J is a positive integer) words from the extracted A word group based on appearance frequency; and
determining a centroid vector, which is a semantic center, based on a vector distribution of the selected J words, and
the extracting and providing of the topic words comprises calculating semantic similarities between the centroid vector of a J word group and respective word vectors of the J word group and selecting topic word candidates in order of decreasing semantic similarity.

10. The method of claim 7, further comprising providing a vocabulary level test to general users and maintaining the word graph according to changes of words with regions and times by applying selection information of the users to the word graph through interaction with the users.
